(19) United States
(12) Patent Application Publication
(10) Pub. No.: US 2013/0030868 A1
(43) Pub. Date: Jan. 31, 2013

(54) Scheduled Split Testing

(71) Applicants: Clifford Patrick Lyon, Melrose, MA (US); Ron Hyman Rothman, Bridgewater, NJ (US)

(72) Inventors: Clifford Patrick Lyon, Melrose, MA (US); Ron Hyman Rothman, Bridgewater, NJ (US)

(73) Assignee: CBS Interactive, Inc., San Francisco, CA (US)

(21) Appl. No.: 13/287,827

(22) Filed: Nov. 2, 2011

Related U.S. Application Data
(63) Continuation-in-part of application No. 13/190,320, filed on Jul. 25, 2011.
(60) Provisional application No. 61/536,816, filed on Sep. 20, 2011.

(51) Int. Cl. G06Q 30/02

(52) U.S. Cl. 705/7.33; 705/7.29

(57) ABSTRACT

A set of enrollment buckets are allocated to a business unit and are subdivided such that a portion of the enrollment buckets are allocated to at least one test. A user ID can be hashed using a first hash function to map the user to one of the enrollment buckets. A set of test buckets are also subdivided such that a portion of the buckets are allocated to one or more test groups and a portion of the test buckets are allocated to the control group. If the user was mapped to a bucket that is allocated to test in the set of enrollment buckets, the user ID will again be hashed using a second hash function to map the user to one of the test buckets.

### CROSS REFERENCE TO RELATED APPLICATIONS

This application is a continuation-in-part of U.S. Utility patent application Ser. No. 13/190,320, filed Jul. 25, 2011, and also claims the benefit of U.S. Provisional Patent Application No. 61/536,816, filed Sep. 20, 2011, the disclosures of which are incorporated herein by reference in their entirety.

### BACKGROUND

1. Technical Field

The present disclosure relates to market testing and more specifically to scheduled split testing by assigning user IDs to mutually exclusive groups.

2. Introduction

Market testing is an important part of almost every consumer-oriented business. Websites and Internet components of businesses have an advantage in that market testing can be conducted easily and at relatively low cost compared to “real-world” focus groups, and the testing can be conducted without the knowledge (and, therefore, bias) of the consumer. In most cases these tests evaluate a change in webpage design, content or features.

As with any test, variables must be tightly controlled in order to understand the cause of any variance between test results and historical performance. A typical way of achieving this is to use a control group in addition to the experimental test groups. Such testing—wherein a population is divided into a control group and one or more test groups—is well known and often referred to as split testing.

When split testing, a tester will often choose to enroll only a limited percentage of an entire audience into a test. In a test on a website, a determined percentage of users visiting the website can be enrolled into a test at random. In a naïve implementation, every visitor who is not already enrolled into a test is subject to the random possibility of being enrolled into the test. However, this technique results in a slow increase in the percentage of users enrolled because unenrolled users are continually subject to new chances for enrollment.

For example, consider that a test is meant to enroll ten percent of the total 1,000 visitors to a website and the test is to run for one week. A user who visits the website multiple times is subjected to the possibility of being selected for the test each time he visits the website. Such “double jeopardy” for unenrolled users results in a gradual increase in the proportion of users enrolled into the test beyond the intended ten percent.

An additional consideration is that prior art split testing techniques often are not suitable for businesses with many different business units. Identification of users who appear in the user populations of multiple business units needs to be accounted for in some testing scenarios. The ability to restrict a user to one test within a business unit would offer protection against “shadow” or “halo” interaction effects while still allowing multiple business units in the network to enroll a particular user at the same time. A further consideration is that users making return visits are not treated uniformly on subsequent visits to the website. Such inconsistent treatment can conflate control and test group experiences. Users making return visits should be handled consistently when they return to a website.

### SUMMARY

Additional features and advantages of the disclosure will be set forth in the description that follows. They will be obvious from the description or can be learned by practice of the herein disclosed principles. The features and advantages of the disclosure can be realized and obtained by means of the instruments and combinations of embodiments particularly pointed out in the appended claims. These and other features of the disclosure will become more fully apparent from the following description and appended claims, or can be learned by the practice of the principles set forth herein.

Disclosed are systems, methods, and non-transitory computer-readable storage media for scheduling users into tests. In a preferred embodiment the users are visitors to a website, and the website administrator desires to know how the population of users is likely to react to one or more new features, layouts, content items, etc. on the website. The website administrator can configure the present technology to schedule a percentage of the visitors to the website into a test in such a fashion that the user is treated consistently during each visit to the website and that avoids errors that are common in other testing systems, particularly those in which visitors are repeatedly assessed for inclusion into a given test.

In one embodiment a first set of user groups called “enrollment buckets” is allocated to a business unit. The enrollment buckets can be subdivided such that a portion of the enrollment buckets is allocated to at least one test. When a user navigates to the webpage, a user ID associated with the user can be hashed using a first hash function to map the user to one of the enrollment buckets.

A second set of buckets called “test buckets” is also subdivided such that a portion of the buckets is allocated to a test variation (other portions can also be allocated to other test variations, if applicable) and a portion of the test buckets is allocated to a control group. If the user was mapped to a hash bucket that is allocated to a test in the enrollment buckets, the user ID will again be hashed using a second hash function to map the user to one of the test buckets.

Users whose user IDs have been mapped to a test variation according to the test buckets will be exposed to the test page or test page element(s) corresponding to that variation of the test. Users whose user IDs have been mapped to the control group will be exposed to the control page or control page element(s).

In some embodiments the user's ID can be combined with additional information before it is hashed by the one or more hash functions. For example, in an enterprise of many different business units it might be desirable, in some situations, to combine the user's ID with a business unit ID which corresponds to the web page the user is visiting. In these embodiments the user can be recognized as a unique user to the system when accessing the system through different portals, when such is desired.

In some embodiments the first and second hash function can be the same hash function. Persons of skill in the art will recognize the appropriateness of selecting different hash functions for specific systems.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an exemplary system embodiment;

FIG. 2 illustrates an exemplary method embodiment for setting up a split test;

FIG. 3 illustrates exemplary enrollment buckets divided into subsets;

FIG. 4 illustrates exemplary test buckets divided into test groups and a control group;

FIG. 5 illustrates an exemplary embodiment of enrollment buckets containing a map;

FIG. 6 schematically illustrates a hash function assigning a user to a bucket based on a user ID;

FIG. 7 illustrates an exemplary embodiment of running a split test on a webpage;

FIG. 8 illustrates an exemplary embodiment of how a publisher ID can be used in an environment with one or more business groups;

FIG. 9 illustrates an exemplary system for implementing the present technology;

FIG. 10 illustrates an exemplary structure of storing collected data;

FIG. 11 illustrates an exemplary method of running perpetual tests;

FIG. 12 illustrates an exemplary embodiment of multiple publishers being combined to create a super-publisher and how to set up a multi-publisher test;

FIG. 13 illustrates an exemplary embodiment of a multi-publisher and single publisher tests being run by the two publishers concurrently; and

FIG. 14 illustrates an exemplary embodiment of a method for administering a multi-publisher test.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

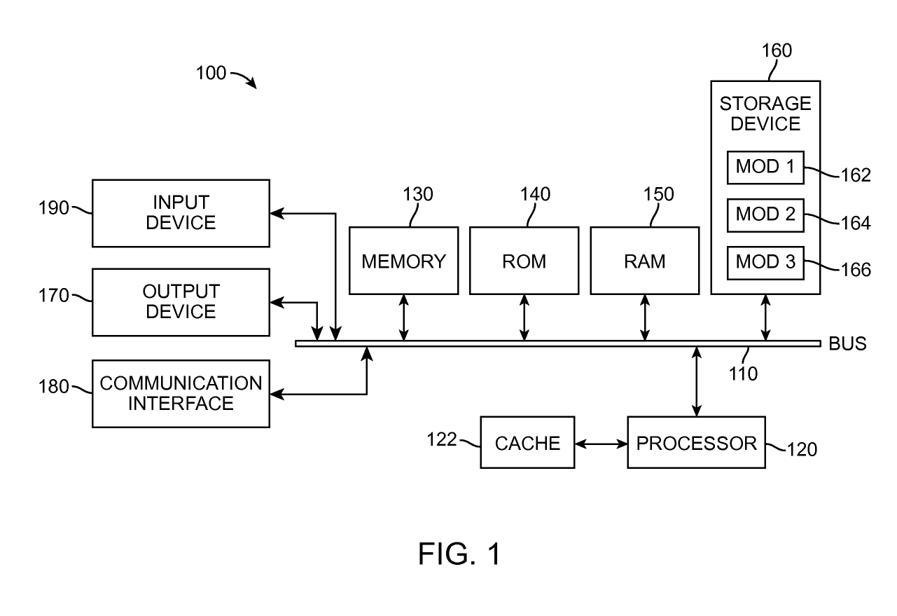

With reference to FIG. 1, an exemplary system 100 includes a general-purpose computing device 100, including a processing unit (CPU or processor) 120 and a system bus 110 that couples various system components including the system memory 130 such as read only memory (ROM) 140 and random access memory (RAM) 150 to the processor 120. The system 100 can include a cache 122 of high speed memory connected directly with, in close proximity to, or integrated as part of the processor 120. The system 100 copies data from the memory 130 and/or the storage device 160 to the cache 122 for quick access by the processor 120. In this way, the cache 122 provides a performance boost that avoids processor 120 delays while waiting for data. These and other modules can control or be configured to control the processor 120 to perform various actions. Other system memory 130 may be available for use as well. The memory 130 can include multiple types of memory with different performance characteristics. It can be appreciated that the disclosure may operate on a computing device 100 with more than one processor 120 or on a group or cluster of computing devices networked together to provide greater processing capability. The processor 120 can include any general purpose processor and a hardware module or software module, such as module 1 162, module 2 164, and module 3 166 stored in storage device 160, configured to control the processor 120 as well as a special-purpose processor where software instructions are incorporated into the actual processor design. The processor 120 may essentially be a completely self-contained computing system, containing multiple cores or processors, a bus, memory controller, cache, etc. A multi-core processor may be symmetric or asymmetric.

The system bus 110 may be any of several types of bus structures including a memory bus or memory controller, a peripheral bus, and a local bus using any of a variety of bus architectures. A basic input/output (BIOS) stored in ROM 140 or the like, may provide the basic routine that helps to transfer information between elements within the computing device 100, such as during start-up. The computing device 100 further includes a storage device 160 such as a hard disk drive, a magnetic disk drive, an optical disk drive, tape drive or the like. The storage device 160 can include software modules 162, 164, 166 for controlling the processor 120. Other hardware or software modules are contemplated. The storage device 160 is connected to the system bus 110 by a drive interface. The drives and the associated computer readable storage media provide nonvolatile storage of computer readable instructions, data structures, program modules and other data for the computing device 100. In one aspect, a hardware module that performs a particular function includes the software component stored in a non-transitory computer-readable medium in connection with the necessary hardware components, such as the processor 120, bus 110, output device 170, and so forth, to carry out the function. The basic components are known to those of skill in the art and appropriate variations are contemplated depending on the type of device, such as whether the device 100 is a small, handheld computing device, a desktop computer, or a computer server.

Although the exemplary embodiment described herein employs the storage device 160, it should be appreciated by those skilled in the art that other types of computer readable media which can store data that are accessible by a computer, such as magnetic cassettes, flash memory cards, digital versatile disks, cartridges, random access memories (RAMs) 150, read only memory (ROM) 140, a cable or wireless signal containing a bit stream and the like, may also be used in the exemplary operating environment. Non-transitory computer-readable storage media expressly exclude media such as energy, carrier signals, electromagnetic waves, and signals per se.

To enable user interaction with the computing device 100, an input device 190 represents any number of input mechanisms, such as a microphone for speech, a touch-sensitive screen for gesture or graphical input, keyboard, mouse, motion input, speech and so forth. An output device 170 can also be one or more of a number of output mechanisms known to those of skill in the art. In some instances, multimodal systems enable a user to provide multiple types of input to communicate with the computing device 100. The communication interface 180 generally governs and manages the user input and system output. There is no restriction on operating on any particular hardware arrangement and therefore the basic features here may easily be substituted for improved hardware or firmware arrangements as they are developed.

For clarity of explanation, the illustrative system embodiment is presented as including individual functional blocks including functional blocks labeled as a “processor” or processor 120. The functions these blocks represent may be provided through the use of either shared or dedicated hardware, including, but not limited to, hardware capable of executing software and hardware, such as a processor 120, that is purpose-built to operate as an equivalent to software executing on a general purpose processor. For example the functions of one or more processors 120 presented in FIG. 1 may be provided by a single shared processor or multiple processors. (Use of the term “processor” should not be construed to refer exclusively to hardware capable of executing software.) Illustrative embodiments may include microprocessor and/or digital signal processor (DSP) hardware, read-only memory (ROM) 140 for storing software performing the operations discussed below, and random access memory (RAM) 150 for storing results. Very large scale integration (VLSI) hardware embodiments, as well as custom VLSI circuitry in combination with a general purpose DSP circuit, may also be provided.

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits. The system 100 shown in FIG. 1 can practice all or part of the recited methods, can be a part of the recited systems, and/or can operate according to instructions in the recited non-transitory computer-readable storage media. Such logical operations can be implemented as modules 162, 164, 166 configured to control the processor 120 to perform particular functions according to the programming of the module. For example, FIG. 1 illustrates three modules Mod1 162, Mod2 164 and Mod3 166 which are modules configured to control the processor 120. These modules may be stored on the storage device 160 and loaded into RAM 150 or memory 130 at runtime or may be stored as would be known in the art in other computer-readable memory locations.

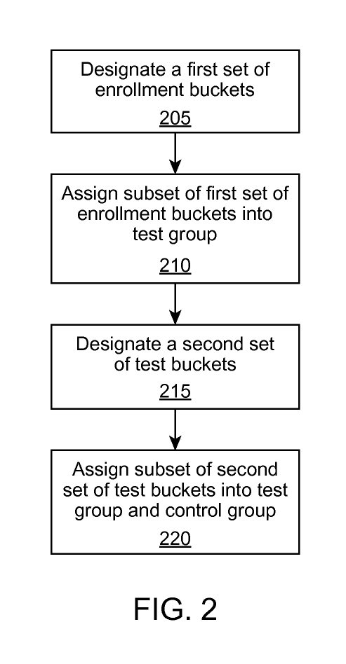

Having disclosed some components of a computing system 100, the disclosure now turns to FIG. 2, which illustrates an exemplary method embodiment for setting up a split test. A website administrator can decide to run a test whereby some users visiting the website can be shown a variation of the website. The variation can be a remodeled page layout or presentation, alternative content, features, etc. When setting up a test, the tester (the site administrator or other entity) can determine that only a limited amount of the site traffic should be exposed to the test. For example, in a site receiving page views from 10,000 unique users, the tester can determine that 30%, or 3,000 users, should be enrolled in the test.

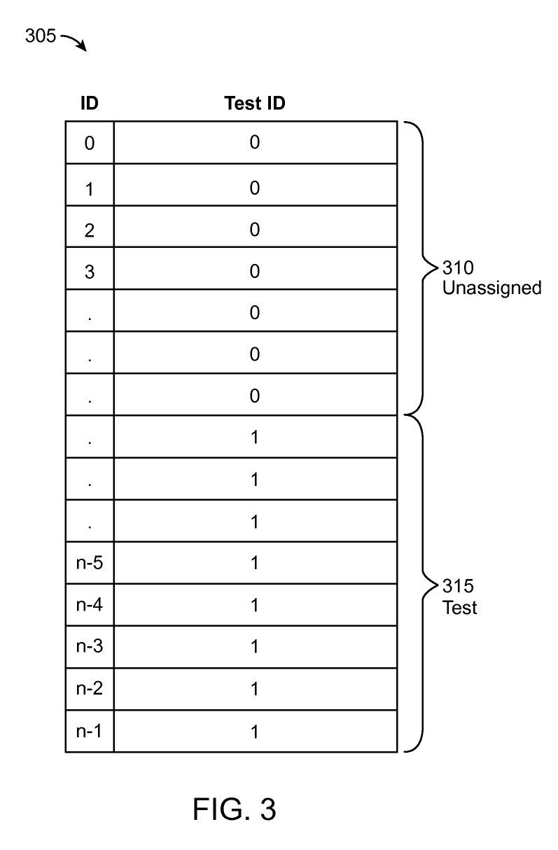

The present technology sets up a test by designating a first set of buckets 205 called “enrollment buckets.” The buckets can be any type of data structure known to those skilled in the art, such as an array. In some embodiments, each bucket can be configured to contain a test ID signifying what test, if any, a user should be enrolled. A test ID can be any variable such as an integer or string which can be used to assign a value to the bucket. By defining the test ID value for each bucket, a subset of the enrollment buckets can be assigned into one or more test groups 210. FIG. 3 graphically illustrates these steps. The enrollment buckets 305 are shown and, as illustrated, each bucket contains an ID number and test ID. The test ID for each bucket has been assigned an integer value of either 0 or 1 to signify whether a bucket is assigned to a test (1) or unassigned (0). The enrollment buckets 305 have been divided into subsets 310 and 315 and wherein subset 315 has been assigned as a test group while subset 310 remains unassigned. In this example the unassigned buckets 310 and test buckets 315 are two contiguous groups of buckets, but this is merely for ease of description and is not meant to be limiting. The buckets can be assigned in any order. Further, the number of tests is not limited to one; any number of tests can be assigned.

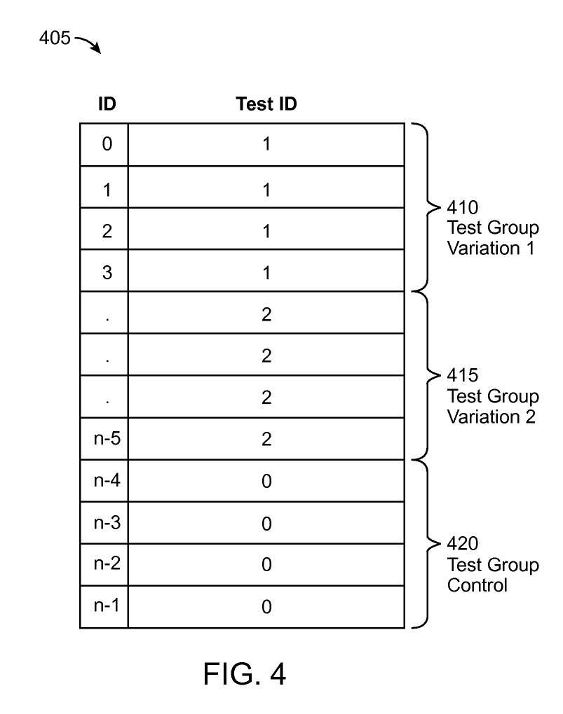

Returning to FIG. 2, a second set of buckets called “test buckets” is also designated 215. Each test bucket can contain a test ID variable which can be assigned a value to divide the test buckets into subsets assigned into one or more test groups and a control group 220. FIG. 4 illustrates the test buckets 405, each containing an ID and test ID variable, which in this case is an integer. The assigned test ID designates which test variation or control group a bucket is assigned. As illustrated, each test ID has been assigned a value of 0 (control), 1 (variation 1), or 2 (variation 2) and the test buckets 405 have been divided into “test group-variation 1” 410, “test group-variation 2” 415, and “test group-control” 420. As will become clear in the following discussion, the users from FIG. 3 assigned to the test group 315 in the enrollment buckets are hashed into the test buckets 405 from FIG. 4.

In some embodiments, each of the enrollment buckets can include a map which allows each bucket to be assigned to a given test according to a map key. For example, if the map key is date, the test ID can be assigned individually for each day. A tester can, therefore, schedule and inventory a test in advance. For example, if the map key is date and the map is configured to accept 30 inputs, a tester can assign the test ID for the bucket for the next 30 days so that the bucket is assigned according to the value of the test ID assigned to the specific day. Although date is used as an example, the map key can be any interval such as week, month, hour, etc. In some embodiments, the map key is not based on time, for example a map key can be whether a user is a first time visitor, or some other characteristic of a user, connection, or other known or detectable attribute.

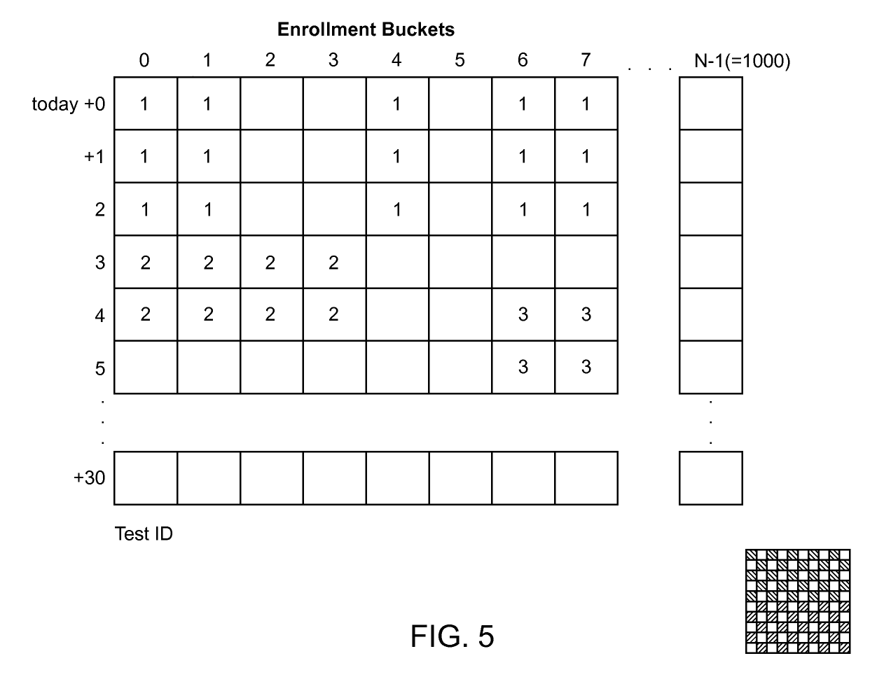

FIG. 5 illustrates an exemplary embodiment of enrollment buckets containing a map. As illustrated each of the enrollment buckets contains a map based on date for the next 30 days which outlines which test, if any, the bucket is assigned for that day. This way, testers can easily schedule their future tests. For example, bucket 0 will be assigned the test corresponding to the test ID stored in the map for the corresponding date. As illustrated, for the current day (0) and the following two days (+1 & +2), bucket 0 is assigned test ID 1. For the following two days (+3 & +4), bucket 0 is assigned to test ID 2. Using the map, testers can schedule their tests in advance. Further, testers can easily schedule tests to test time intervals such as weekends, evenings, mornings, etc. For example, a tester can schedule tests to determine performance on only the weekends or in the evenings.

The number of enrollment buckets as well as the number of buckets assigned in their corresponding subsets can be configured to test any predetermined percentage of users. Returning to FIG. 3, for example, if a tester wants 30% of users to be enrolled in a test, the tester can designate 1000 buckets to be the enrollment buckets 305 and then assign a subset of 300 of those 1000 buckets to be a test group 315. In this example, the enrollment buckets 305 can be labeled enrollment buckets 0-999 (1000 total), the subset left unassigned 310 can include enrollment buckets 0-699 (700 total) and the subset assigned to the test group 315 can include enrollment buckets 700-999 (300 total).

The same concept can be used to employ multiple test variations as shown in FIG. 4. For example, if the tester wants 33% of users to be enrolled in test variation 1 410, 33% to be enrolled in test variation 2, and the remaining users to be in the control group 420, the tester can designate 1000 test buckets 405 and then assign a subset of 333 of those buckets to test variation 1 410, another subset of 333 buckets to test variation 2 415, and the remaining subset of 334 buckets to the control group 420.

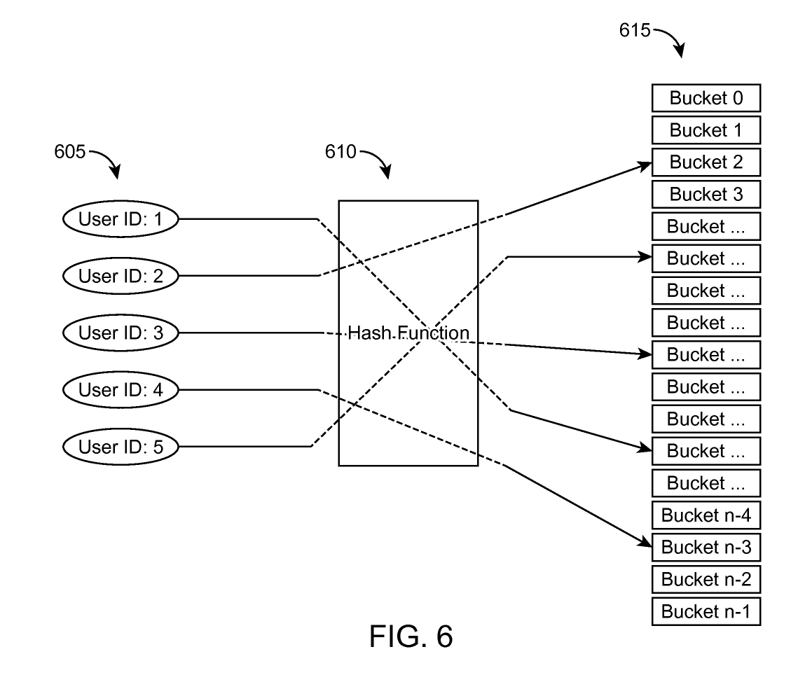

To assign a user to a bucket, a user ID assigned to a user is entered into a hash function which associates the user ID with a bucket. FIG. 6 schematically illustrates how a hash function assigns a user to a bucket based on a user ID. As illustrated, user IDs 605 are inputted into a hash function 605, which assigns the user to a bucket 610.

The hash function can be any method of hashing known to one of skill in the art. However, it is that the specific function that is selected consistently assign users with the same user ID to the same bucket such that every time an identified user returns to the system the user will be treated in the same fashion as in previous visits. In addition, it is preferable that the function exhibit random uniformity such that roughly the same number of users is assigned to each bucket.

A hash function may also incorporate a modulo operation to ensure that each hash key is assigned to a bucket within the assigned range. For example, if 10,000 user IDs are hashed, and only 1000 buckets are configured, the hash function may apply a modulo operator that divides by the total number of buckets, in this example 1000, and then returns the remainder to ensure that the user IDs are only hashed to buckets 0-999. For example, if the user ID inputted into the hash function returned 2,325, the modulus function would divide by 1000 and return the remainder of 325. The user ID would then be assigned to bucket 325. The modulo operator may be incorporated into the hash function itself or applied to the output of the hash function.

The user ID assigned to a user can be created using any well-behaving method of ID assignment. For example, in some embodiments Apache's mod_unique_id is used. The user ID can be stored as a cookie in the user's browser, however other client-side storage mechanisms or session-based methods can be used, as can session-based methods. In some embodiments HTML5's local storage feature can be used.

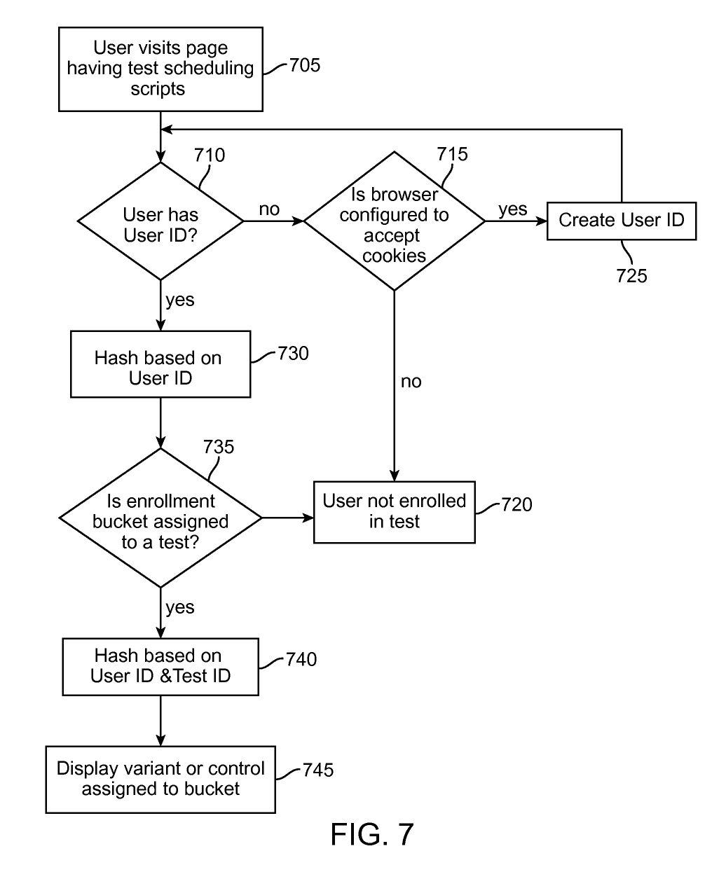

FIG. 7 illustrates an exemplary embodiment of running a split test on a webpage. A user can navigate to a website 705 using a web browser running on a computing device. To configure and run a split test, a test script (e.g., JavaScript code) can be embedded within a web page on which the test is to run. The test script communicates with a test server which is configured to run the test. The script can check whether a user has a user ID 710. In some embodiments the user ID can be stored as part of a cookie placed on the user's computing device. If the user does not have a user ID 710, the script can check whether the user's web browser is configured to accept cookies 715. If the user's browser is configured to not accept cookies then the user is not enrolled into a test 720. If the user's browser is configured to accept then a user ID is created and stored on the user's device 725.

In some embodiments the method determines whether the user's computer accepts cookies by attempting to set a cookie while responding to the user's initial request with an HTTP redirect. If the user's browser accepts cookies, the newly created user ID will be stored in the user's browser. The new location of the HTTP redirect can be identical to the original URL except for a new query argument added to the URL query parameters. This query parameter is a “cookied already” flag which indicates that there has been an attempt to set the cookie, so that infinite redirects can be avoided when a client is not accepting cookies. If a request is received with the flag set, but no user ID is present in the call, then it can be concluded that the user has cookies disabled and the user will not participate in the test.

In some embodiments reliable and consistent assignment of a user to a bucket can be accomplished without using scripts on a webpage and without storing cookies with assigned user IDs. In such embodiments the website can require that a user first sign in using a user account such that the user can be uniquely identified.

When the script determines that a user does have a user ID 710, the user ID is sent to the test server and entered into a hash function 730 where it is associated with an enrollment bucket. In some embodiments, the hash function may output a number that is entered into a modulo function to ensure the output is within the range of buckets. In some embodiment the modulus function may be incorporated into the hash function so that the hash function assigns the user to a bucket.

After a user ID has been hashed to an enrollment bucket 730, it is determined whether the bucket is assigned to a test or remains unassigned 735. This can be done by checking the test ID associated with the bucket. If the bucket is not assigned to a test 735 then the user is not enrolled into a test 720. If the bucket is assigned to a test 735 then the user's user ID is hashed into the test buckets 740 associated with the test to which the enrollment bucket was assigned. If the user ID was hashed to a test bucket assigned to a test variation then the test variation is displayed to the user 745. If the user was hashed to a test bucket assigned to the control then control 745 is displayed to the user.

One advantage of the present technology is that a user is treated consistently every time he returns to the website. Because the enrollment buckets and the test buckets are predetermined, and because the user is consistently assigned to the same bucket, his treatment will be the same on return visits. The present technology also takes into account that a user might access the testing system through multiple business units of the same company. While the present technology has been discussed primarily with respect to hashing users into enrollment and test buckets, it should be appreciated that any method that consistently assigns users into buckets can be used consistent with the other principles of the present technology herein.

Thus far, the present technology has been primarily discussed with respect to a single website or single publisher environment. However, some embodiments of the present technology are suitable for larger publishers with more than one property. Within a network of sites, a user should be allowed to participate in more than one test, particularly if those tests are on distinct sites or on distinct sections within a single site, where interaction effects can much more safely be ignored. In some embodiments this can be accomplished by partitioning the website inventory, and the pages on which the tests are to be run can be assigned a partition key. The present invention calls this key “publisher ID.” The publisher ID can represent a site, a group of sites, a publisher, or even an arbitrary collection of pages within a site. In such embodiments, the user ID and publisher ID are hashed together to assign the user into the appropriate bucket.

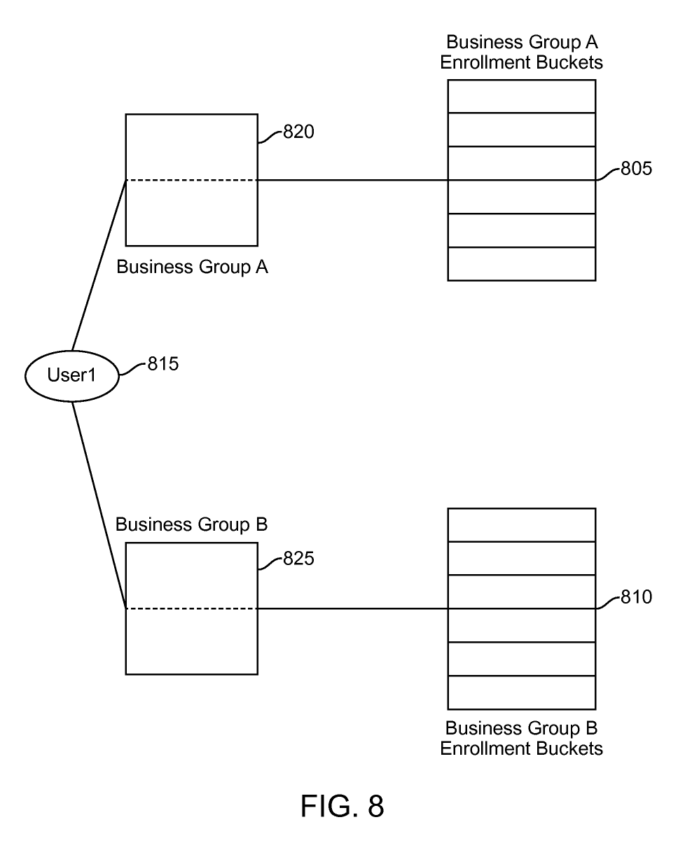

FIG. 8 illustrates an embodiment of how a publisher ID can be used in an environment with one or more business groups. As illustrated, there are two sets of enrollment buckets 805, 810, one for each business group. When a user visits a particular business group, their user ID along with a publisher ID associated with the business group are both used to hash the user to the proper bucket within the enrollment buckets assigned to that particular publisher. As illustrated, a user 815 visiting business group A 820 is hashed into the business group A enrollment buckets 805 while the same user 815 visiting business group B 825 is hashed into the business group B enrollment buckets 810. While the buckets are illustrated as a contiguous block, they need not be contiguous or ordered.

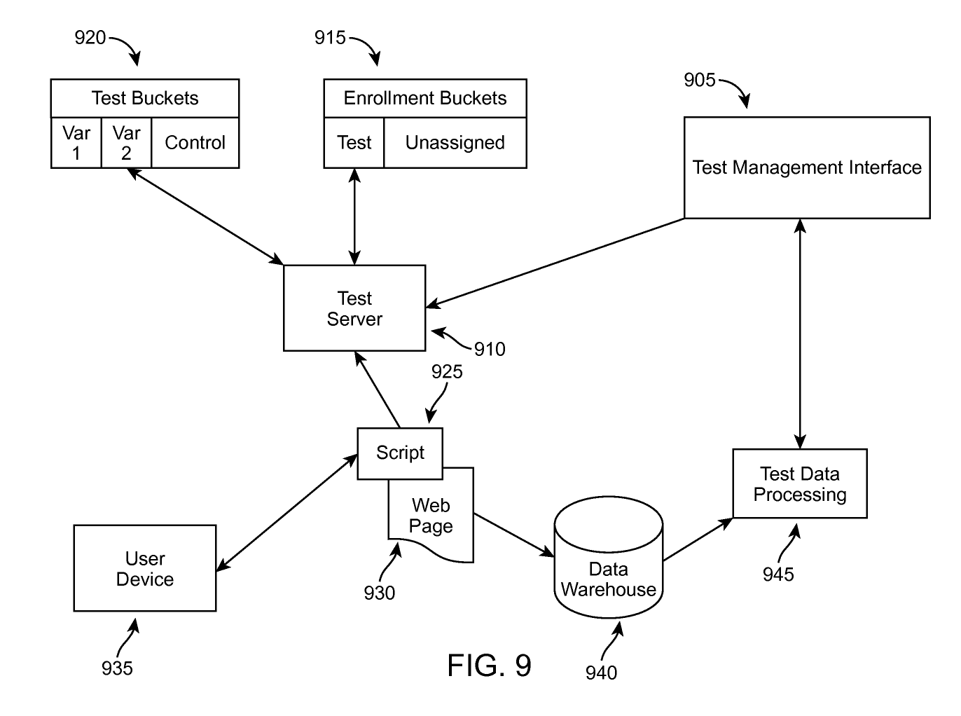

FIG. 9 illustrates an exemplary system for implementing the present technology. A test management interface (TMI) 905 can be configured to communicate with a test server 910. The TMI 905 can be running on the test server 910, or from another server and be networked to communicate with the test server 910 by any method known to those skilled in the art. The TMI 905 can be configured to allow a tester to create a test, schedule a test, upload assets, and retrieve code to paste into a webpage, as well as configure and receive reports about the test.

For example, to create a test, a tester may log in to the TMI 905 and set test parameters such as test name, begin and end dates, metrics to be recorded, percentage of audience to be tested, number of variations, and percentage of tested users to see each variation or control. A tester may also upload any content to be displayed when a user is served a variation of a webpage.

After receiving test parameters from a tester, the TMI 905 initializes the test and then transmits the test data to a test server 910. Initialization may include: designating the enrollment and test buckets 915, 920, assigning subsets of each to meet test parameters, and generating any scripts which may be needed to implement the test. The generated scripts are outputted to the tester to be placed into the web pages to be tested. The scripts can be of any type known by those skilled in the art, e.g. JavaScript.

In one embodiment, a JavaScript script 925 embedded in a webpage 930 to be tested is used to communicate between the test server 910 and the user's computer. The script 925 can be configured to check if a user's device 935 is set to accept cookies, check if a cookie is on the user's device 935, set a cookie on a user's device 935 if allowed, and identify the publisher ID. Publisher ID can be used to partition the website inventory, i.e., the pages on which the tests are to be run. The publisher ID can represent a site, a group of sites, a publisher, an arbitrary collection of pages within a site, etc. The script 925 calls the test server 910, transmitting parameters which may include publisher ID, test ID and user ID (cookie value).

The data sent to the test server 910 from the script 925 is then used to determine whether the user is enrolled in the test, and if so, whether the user should be served a test variation or the control. As explained above, if the script 925 determines that the user ID cookie already exists on the user's device 935, the user ID is sent to the test server 910 where it is used as a key in the first hash function, to be hashed into the enrollment buckets 915. In some embodiments if enrollment buckets 915 have been allocated to multiple business groups as illustrated by FIG. 8, the publisher ID is also sent from the script 925 to the test server 910, then the publisher ID is used by the hash function along with the user ID. If no cookie was present on the user's device 935, a user ID is assigned by the test server 910 and entered into the first hash function. Additionally the user ID will be set on the user's device 935 by the script 925, e.g. as a cookie.

If the user ID is hashed into a bucket assigned to a test in the enrollment buckets 915, the user ID is then entered into the second hash function to be assigned to a test bucket 920. Depending on whether the user ID is hashed into a test bucket 920 assigned to a test variation or control, the corresponding content is served to the user. A test group ID identifying which variation was served is also returned to the script 925.

A record of the user's interaction with the website 930 as well as the test ID are collected at a data warehouse 940 and then processed by a test data processing application 945. Metrics derived from this record compare user behavior between the control group and variations. Statistical tests determine whether differences between the control group and the variations are significant. Metrics collected can include, but are not limited to: amount of time the user spent on the site, which links were clicked, which site the user entered from, the time of day, the day of the week etc. A metric can also be a ratio where the numerator is a sum or count of some value and the denominator is a count of users or sessions that produced the value. The metric can also be calculated for a portion of the total audience, referred to as a dimension, rather than the full audience. Some of examples of dimensions include: new visitors, weekend visitors, visitors arriving from a search engine, registered users, etc. Different tests can use different dimensions and/or different metrics. In some embodiments, the collected data can be stored in a predetermined structure.

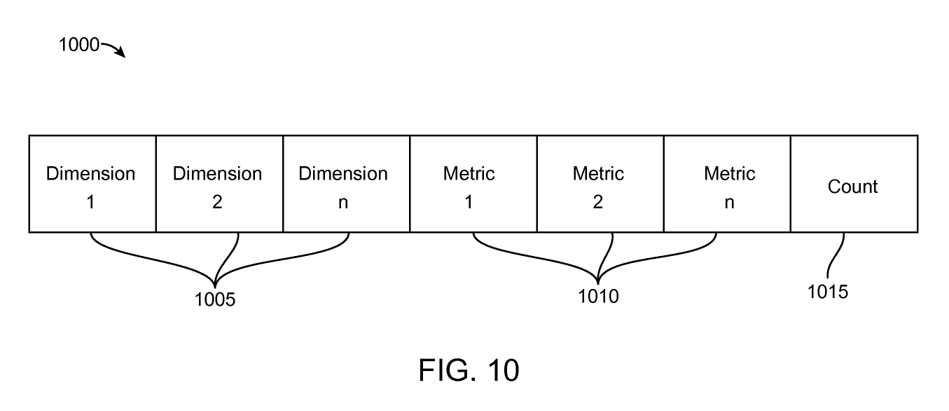

FIG. 10 illustrates an exemplary structure of storing collected data. As illustrated different dimensions 1005 are stored first in a list 1000, followed by different metrics 1010 and finally a count 1015 of the total sample. This type of data structure can be used to perform a test of a given metric on any combination of dimensions as well as allow a tester to include multiple metrics for a test. For example, the illustrated data structure can be used to compute the mean and variance for any metric by any combination of the dimensions. Test data can be stored by any chosen time interval such as day, hour or minute. Returning to FIG. 9, this data is then processed by a test data processing application 945. The test data processing application 945 can be configured by using the TMI 905. The TMI 9905 allows a tester to choose what metrics to be viewed and to create reports which may be viewed through the TMI 905.

Using the technology described herein users can be effectively scheduled to participate in a test and be treated in a consistent manner. The present technology gives the tester greater control over the population selected for the test, thus reducing unanticipated errors and tainting the test candidate pool with other tests.

In some embodiments, each bucket can contain a map with keys corresponding to different values. For example, in some embodiments a map's keys can be dates such that a bucket can be mapped into each day from the present day through the following 30 days and the map's values are lists of tests, each of the lists of tests representing the tests in which the users of the bucket will participate on the specified date. In some embodiments the list length can be limited to 1 to completely avoid potential problems caused by test interaction. Although date has been chosen as an example of the key, a key with a finer granularity can be used. For example, tests can be scheduled by the hour or minute. Users can only participate in the tests to which they are assigned.

Returning to FIG. 9, the map can be used to inventory tests in advance by a tester. The test server 910 can be configured to keep track of how much of the audience each tester has assigned into a test for each day in the future, which prohibits a tester from overscheduling tests; that is, from allocating more than 100% of the tester's audience on any day for the duration of the test. The system can also schedule the test's audience allocation and allocate future audience to that test. For example, if a tester schedules a test in which 25% of its audience should participate, and there are 1000 user buckets, the test server 910 can find 250 buckets (25% of 1000) into which the test “fits” over the entire chosen duration of the proposed test. In addition, the system may increase the percentage of the audience enrolled in a test over the duration of the test, e.g., the test may begin with a 2% allocation and ramp up to 50% over time. A test can fit in a bucket if there are no conflicting tests already in that bucket. When setting up a new test, a tester can choose to isolate the test from other tests. For example, a tester can determine that two different tests conflict, and so a tester can choose to not include the two conflicting tests in the same bucket. In some embodiments a tester can choose to isolate two tests to prevent test interactions from skewing results.

In some embodiments the test server 910 can be constrained so that once buckets are chosen for a proposed test, the buckets cannot be changed over the course of the test. This ensures that users do not shift among multiple variations during the test. In this type of embodiment, the test server 910 can find buckets which are free for the entire duration of a proposed test, and those buckets remain that test's buckets for the entire duration. New buckets can be added to the test; however, none can be removed. In some embodiments, the buckets can be reallocated on future days as long as all users who hash into a given bucket will continue to hash to the same set of tests during the duration of the test.

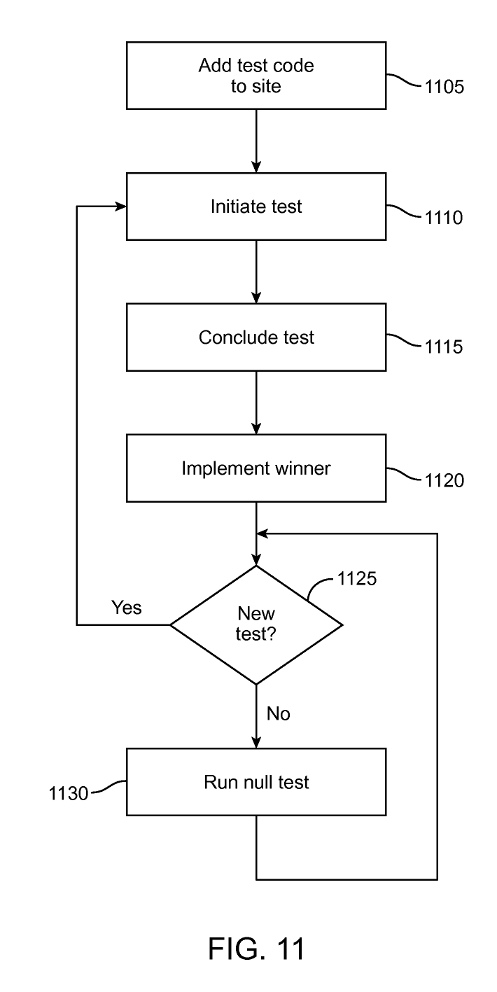

FIG. 11 illustrates an exemplary method of running perpetual tests. Generally a test is run for a specified duration and when completed the code for running the test is removed. In some embodiments, the code can remain a part of the page so that can be tested multiple times without the set up and tear down costs. At step 1105 a tester adds test code to their site. At step 1110 the tester initiates the test. At step 1115 the test is completed and a determination is made as to whether a variation or the original is most effective. At step 1120 the tester can implement the winning variation. In some embodiments the winning variation can be implemented globally. In some embodiments, the tester can implement the winning variation based on a dimension or user segment so that the winner is shown for each segment. At step 1125 the method determines whether a new test is going to be run. If a new test is going to be run, the method returns to step 1110 and a new test is initiated. If a new test is not going to be run, a null test can be run 1130 until it is determined that a new test will be run.

In some embodiments a test can be run across multiple publishers. For example a publisher or collection of publishers may wish to make a change across multiple divisions of their company and view the results as a whole with a consistent set of users enrolled in the test across each site. For example, an enterprise that has separate news and sports web sites may treat those as distinct publishers; however, a tester may instead wish to test a common change across both sites. To accomplish this goal a tester can group multiple publishers together to create a super-publisher and run a test so that users are hashed into the same set of enrollment buckets when they enter a site from any of the publishers within the test. In some embodiments a user's ID will be consistent across all publishers so that users are treated consistently when entering the test from multiple sites.

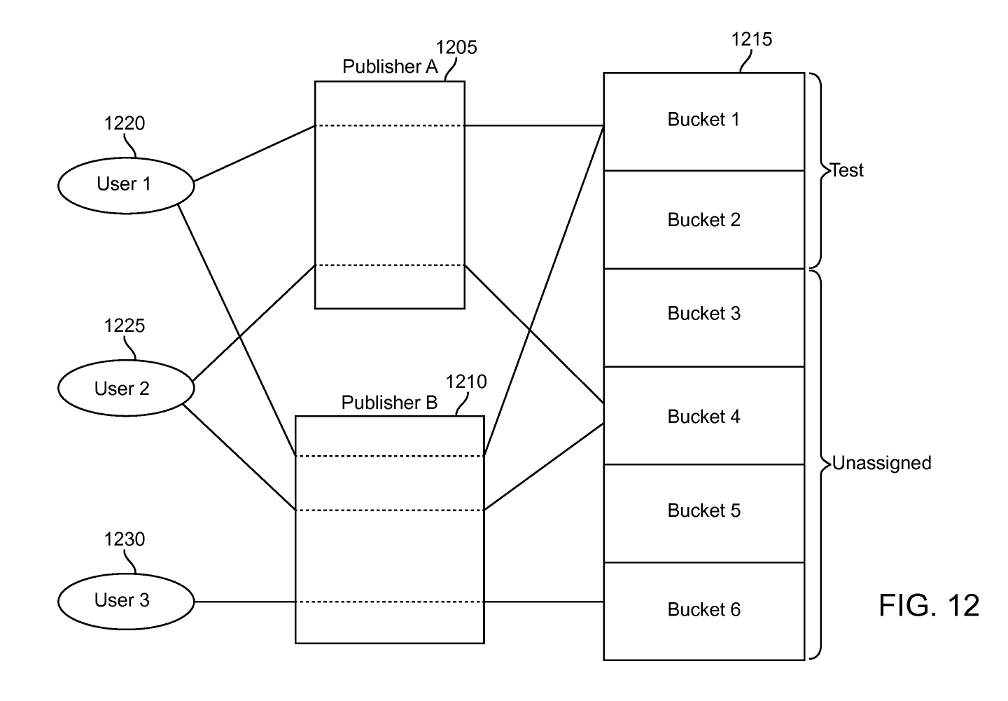

FIG. 12 illustrates an exemplary embodiment of multiple publishers being combined to create a super-publisher and how to set up a multi-publisher test. As illustrated, a test can be run across two business units or publishers, Publisher A 1205 and Publisher B 1210. In such embodiments, the two publishers can effectively pool their respective user populations into one population. The user ID of a user entering either site can be hashed consistently into the same set of enrollment buckets 1215 so that a user will be hashed into the same bucket regardless of which publisher they enter from. As illustrated, when User 1 1220 enters from Publisher A 1205 their user ID is hashed into bucket 1 which has been assigned to a test. When User 1 1220 enters from Publisher B 1210, their user ID is hashed into bucket 1, the same bucket which the user was hashed into when entering from Publisher A 1220. User 2 1225, is also hashed consistently regardless of the publisher through which User 2 1225 enters. As illustrated, User 2 1225 is hashed into bucket 4 whether entering from Publisher A 1205 or Publisher B 1210. Hashing the users consistently can ensure that the test is being administered consistently across both publishers, as if they were one super-publisher, so that the same users will be enrolled in a test regardless of which publisher they enter from. Some users may only visit one of the publishers that are running the test. For example, User 3 1230 only visits Publisher B and is hashed into bucket 6 which is not assigned to be in the test, if User 3 1230 were to visit Publisher A, User 3 would also be hashed into bucket 6. Whether a user visits one, some, or all of the publishers in a test does not affect what bucket the user will be hashed into; the user ID for a user will be consistently hashed.

In some embodiments a publisher can run a test across multiple publishers while concurrently running a single publisher test. For example, Publisher A can be a part of a multi-publisher test with Publisher B and run a single publisher test at the same time. In some embodiments, a publisher can designate a portion of their total user traffic to be for the multi-publisher test while a portion of the remaining user traffic can be designated to participate in another test running on the publisher's site.

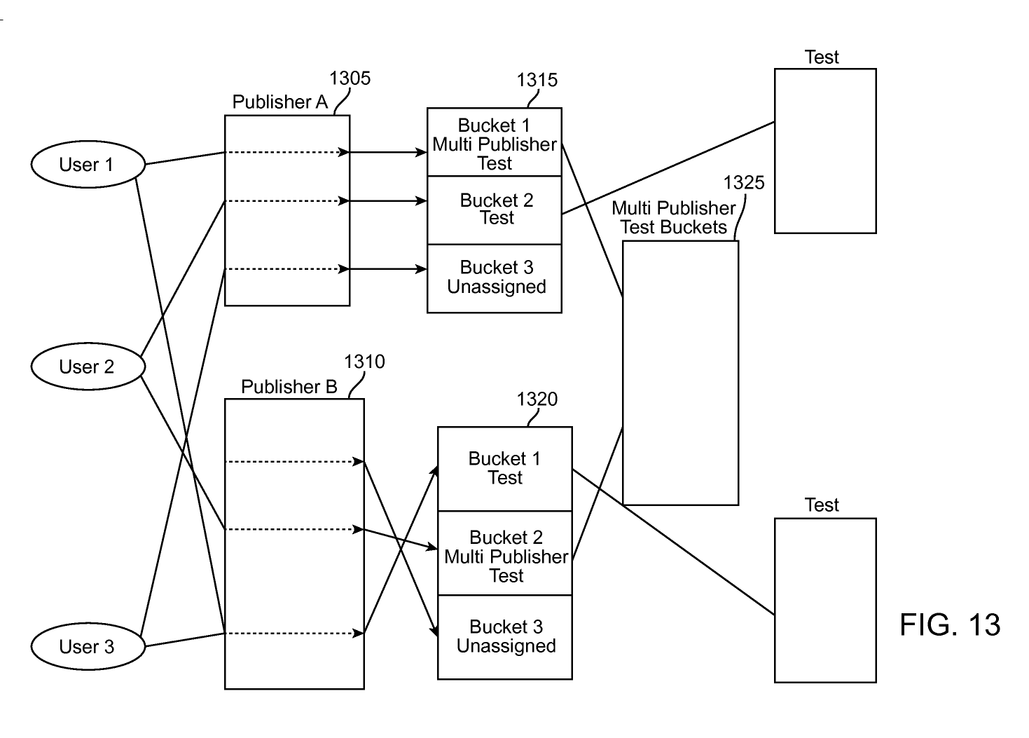

FIG. 13 illustrates an exemplary embodiment of a multi-publisher and single publisher tests being run by the two publishers concurrently. As illustrated, two publishers, Publisher A 1305 and Publisher B 1310 are both running single publisher tests and are also running a multi-publisher test. When a user navigates to the website of either publisher their user ID is hashed into a set of enrollment buckets unique to that publisher. The Publisher A enrollment buckets 1315 have been configured so that Bucket 1 is assigned to the multi-publisher test, Bucket 2 is assigned to a single publisher test and Bucket 3 has been left unassigned. The Publisher B enrollment buckets 1320 have been configured so that Bucket 1 is assigned to a single publisher test, Bucket 2 is assigned to the multi-publisher test and Bucket 3 has been left unassigned. As above, each bucket represents a specified portion of the publisher's website traffic.

When a user visits a publisher site, the user will be consistently hashed into the same enrollment bucket for that publisher. Although a user may be treated consistently every time they visit a publisher, in some embodiments a user may not be treated consistently across multiple publishers. For example, as illustrated, when User 1 enters through Publisher A 1305, User 1 is hashed into Publisher A's Bucket 1 which has been assigned to the multi-publisher test, however when User 1 enters through Publisher B 1310, User 1 is hashed into Publisher B's Bucket 3 which is unassigned.

One potential outcome of the embodiment illustrated in FIG. 13 is that a user can arrive at one publisher's website and not be assigned to a test, while the same user can arrive at another publisher's website and be assigned to a multi-publisher test that includes the first publisher. For example, User 1 discussed above would not be assigned into a test if she navigated to Publisher B's website, but yet User 1 is assigned to a test on Publisher B by virtue of the multi-publisher test through Publisher A. To achieve the goal of treating users consistently across all publishers, such a scenario must be accounted for.

When a user is hashed into an unassigned bucket for a publisher that is part of a multi-publisher test, that user's ID can be hashed into the enrollment buckets of the other publishers in the multi-publisher test to check whether the user has been enrolled in the multi-publisher test. If the user has been enrolled into the multi-publisher test by a different publisher then the user will be treated as part of the multi-publisher test. The user's ID and publisher ID will be hashed into the multi-publisher test buckets 1325 to determine what treatment the user should be given, i.e., test, control, etc.

The embodiment illustrated in FIG. 13 also illustrates another potential outcome wherein a user can be enrolled in two tests simultaneously. For example, User 2 is enrolled in a single publisher test for publisher A, and the multi-publisher test for Publisher B. Such conflicts can be resolved using a simple rule. In some embodiments, when a user is assigned to a test associated with the publisher whose site they have visited, that user will be associated with that test. Using User 2 as an example, when User 2 enters through Publisher A, User 2 is hashed into Bucket 2 and is assigned to a single publisher test. Conversely, when User 2 enters through Publisher B, User 2 is hashed into Bucket 2, which is assigned to a multi-publisher test, and thus the user is assigned to the multi-publisher test.

In some embodiments, the test system can be configured to give priority to a multi-publisher test. In such embodiments, whenever a publisher is enrolled in a multi-publisher test, the system can hash the user ID as if the user had entered through each publisher to determine if the user is part of a multi-publisher test. If the user is part of any multi-publisher test, the user can be preferentially associated with the multi-publisher test.

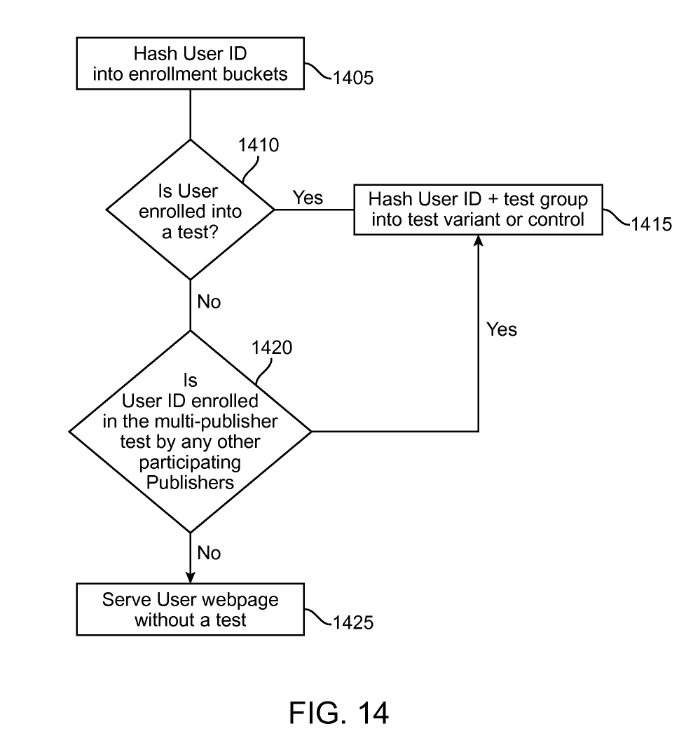

FIG. 14 illustrates an exemplary embodiment of a method for administering a multi-publisher test. At 1405 a user's ID is hashed into the enrollment buckets of the publisher through which the user entered. A user's ID can be hashed consistently so that the user is always assigned to the same bucket within the enrollment buckets. Once a user's ID is hashed into the enrollment buckets, it is determined whether the bucket has been assigned to a test 1410. If the user has been enrolled into a test, the user is further hashed using his User ID and test ID into a test variation or control 1415 as discussed with respect to FIG. 5, above. If at 1410 the user is not enrolled into a test, the method next determines whether the publisher is assigned to a multi-publisher test 1420 by any of the other publishers participating in the multi-publisher test. If not, the user is served the publisher's webpage without a test 1425. If the publisher is part of a multi-publisher test then the user is further hashed using his User ID and test ID into a test variation or control 1415.

Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those of skill in the art will appreciate that other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the scope of the disclosure. Those skilled in the art will readily recognize various modifications and changes that may be made to the principles described herein without following the example embodiments and applications illustrated and described herein, and without departing from the spirit and scope of the disclosure.

We claim:

1. A computer-implemented method comprising:
running a split test on a publisher's website by a testing system wherein the split test comprises providing at least one test variation of the publisher's website to a test group, and providing a control version of the publisher's website to a control group;
analyzing the results of the split test to determine whether the test variation(s) or control version is most effective;
automatically applying the most effective version of the test variation(s) and control version as the default publisher's website.

2. The computer-implemented method of claim 1, wherein the analyzing the results of the split test to determine whether the test variation(s) or control version is most effective determines that one of the variations(s) or control is most effective for a first dimension, and another one of the variations(s) or control is most effective for a second dimension.

3. The computer-implemented method of claim 2, wherein the automatically applying the most effective version includes applying the most effective version for the dimension.

4. The computer-implemented method of claim 1, wherein the split test is run perpetually.

5. The computer-implemented method of claim 1, further comprising:
introducing new variations into the split test.

6. The computer-implemented method of claim 1, wherein users are enrolled into the split test by:
designating a subset of enrollment buckets to the split test;
designating a first subset of test-specific buckets to the control group, and one or more subsets of the test-specific buckets to respective test groups;
mapping a user to one of the enrollment buckets by executing a first hash function on a user ID associated with the user, whereby the user is enrolled into the test when the user ID has mapped to one of the subset of enrollment buckets that is part of the test; and
mapping the user, whose user ID has already been mapped to an enrollment bucket that is part of the test, to one of the test-specific buckets by executing a second hash function on the user ID, whereby the user is determined to be part of a test group or the control group by virtue of being mapped to a test-specific bucket designated as part of the respective test group or the control group, respectively.

7. The computer-implemented method of claim 1, wherein the publisher is one publisher of a group making up a super-publisher sharing a single logical audience.

8. A computer-implemented method comprising:
designating a subset of enrollment buckets to a multi-publisher test, wherein any enrollment buckets not assigned to a test are reserved for future use;
designating a first subset of test-specific buckets to a control group, and one or more subsets of test-specific buckets to one or more respective tests;
mapping a user to one of the enrollment buckets when the user has navigated to a first publisher's website, the first publisher participating in a multi-publisher test, by executing a first hash function on a user ID; and
mapping the user, whose user ID has already mapped to an enrollment bucket that is part of the multi-publisher test, to one of the test-specific buckets by executing a second hash function on the user ID associated with the user, whereby the user is determined to be part of the one or more test groups or the control group by virtue of being mapped to a test-specific bucket designated as part of the respective test group or the control group.

9. The computer-implemented method of claim 8 wherein an additional subset of enrollment buckets is for a publisher specific test.

10. The computer-implemented method of claim 8 further comprising:
determining, when the user has been mapped into an enrollment bucket reserved for future use that the user would be mapped into a multi-publisher test if the user had navigated to a different publisher that is also participating in the multi-publisher test; and
enrolling the user into the multi-publisher test.

11. A system comprising:
a test-server processor;
a first test-server module configured to designate a subset of enrollment buckets to a multi-publisher test, wherein any enrollment buckets not assigned to a test is reserved for future use;
a second test-server module configured to control the processor to designate a first subset of test-specific buckets to the control group, and one or more subsets of the test-specific buckets to respective test;
a third test-server module configured to control the processor to map a user to one of the enrollment buckets by executing a first hash function on a user ID, whereby the user is enrolled into a multi-publisher test when the user ID has mapped to one of the subset of enrollment buckets that is part of the multi-publisher test; and
a fourth test-server module configured to control the processor to map the user, whose user ID has already mapped to an enrollment bucket that is part of the multi-publisher test, to one of the test-specific buckets by executing a second hash function on the user ID, whereby the user is determined to be part of a test group or the control group by virtue of being mapped to a test-specific bucket designated as part of the test group or control group, respectively.

12. The system of claim 11, wherein the first test server module is further configured to determine, when the user has been mapped into an enrollment bucket reserved for future use, that the user would be mapped into a multi-publisher test if the user had navigated to a different publisher that is also participating in the multi-publisher test.

13. The system of claim 12 further comprising:
a fifth test-server module configured to provide the multi-publisher test to the user.

14. A system comprising:
a test server configured to run a split test on a publisher's website by a testing system wherein the split test comprises providing at least one test variation of the publisher's website to at least one test group, and providing a control version of the publisher's website to the control group;
a test data processing module configured to analyze the results of the split test to determine whether the test variation(s) or control version is most effective;
the test server configured to automatically apply the most effective version of the test variation(s) and control version as the default publisher's website.

15. The system of claim 14, wherein the test data processing module is further configured to analyze the results of the split test to determine whether the test variation(s) or control version is most effective determines that one of the variations(s) or control is most effective for a first dimension, and another one of the variations(s) or control is most effective for a second dimension.

16. The system of claim 15, wherein the automatically applying of the most effective version includes applying the most effective version for the dimension.

17. The system of claim 14, wherein the split test is run perpetually.

18. The system of claim 17, further comprising:
a test management interface configured to introduce new variations into the split test.

19. The system of claim 14, wherein the test server is further configured to enroll users into the split test by:
designating a subset of enrollment buckets to the test;
designating a first subset of test-specific buckets to the control group, and a one or more subsets of the test-specific buckets to respective test groups;
mapping a user to one of the enrollment buckets by executing a first hash function on a user ID, whereby the user is enrolled into the test when the user ID has mapped to one of the subset of enrollment buckets that is part of the test; and
mapping the user, whose user ID has already mapped to an enrollment bucket that is part of the test, to one of the test-specific buckets by executing a second hash function on the user ID, whereby the user is determined to be part of a test group or the control group by virtue of being mapped to a test-specific bucket designated as part of the a test group or the control group, respectively.

20. The system of claim 14, wherein the publisher is one publisher of a group of super-publishers all participating in the same test.
